(19) United States
(12) Patent Application Publication
(10) Pub. No.: US 2009/0184566 A1
(43) Pub. Date: Jul. 23, 2009

(54) Axle for Mounting a Wheel for Rotation on a Wood Hobby Vehicle

(75) Inventor: Randall S. Metz, Fenton, MO (US)

Correspondence Address: THOMPSON COBURN LLP, ONE US BANK PLAZA, SUITE 3500, ST LOUIS, MO, 63101, US

(73) Assignee: HOBBYX, LLC, Fenton, MO (US)

(21) Appl. No.: 12/016,657

(22) Filed: Jan. 18, 2008

(51) Int. Cl. B60B 35/00; B60B 37/00

(52) U.S. Cl. 301/131

(57) ABSTRACT

An axle used to mount a wheel for rotation on the body of a wood hobby vehicle is provided with three axially separate cylindrical lands that engage with and support the wheel for rotation, and four axially spaced cylindrical grooves that are interspersed among the lands and reduce the friction between the wheel and the axle as well as provide areas for lubrication between the wheel and the axle.

### BACKGROUND OF THE INVENTION

1. Field of the Invention

The present invention pertains to the design of an axle used to mount a wheel for rotation on the body of a wood hobby vehicle. In particular, the present invention pertains to a metal axle that has three axially separate cylindrical lands that engage with and support the wheel for rotation, and four axially spaced cylindrical grooves that are interspersed among the lands and reduce the friction between the wheel and the axle as well as provide areas for lubrication between the wheel and the axle.

2. Related Art

In the construction of wood hobby vehicles, for example the wood hobby vehicles that are raced in the Pinewood Derby® of the Boy Scouts of America®, the wheels of the hobby vehicles, whether they are constructed of wood or an other material, are typically mounted for rotation on the wood body of the vehicle by a small metal nail, brad, a pin, or a wood screw. The nail has the typical construction of a narrow length with a tip and a head at opposite ends of the nail. The nail tip is inserted through a hole in the center of the wheel and then is inserted into the side of the wood vehicle body in mounting the wheel for rotation on the body.

The friction between the nail axle and the wheel center hole of the hobby vehicle obviously affects the speed of rotation of the wheel and the speed of the hobby vehicle. To reduce the friction and increase the speed of rotation of the wheel on the axle, lubricants such as graphite have been employed between the axle and the wheel. In addition to or as an alternative to lubricating, prior art axles have been provided with polished surfaces to reduce friction. Still further, it is a known practice to file the axles of the hobby vehicle to reduce their diameter and reduce the contact surface between the axle and the wheel center hole, or to form a groove in the axle to reduce the area of contact between the axle and the center hole of the wheel. Although all of these techniques can increase the speed of a hobby vehicle, there is still a competition to find new ways to increase a vehicle's speed.

### SUMMARY OF THE INVENTION

The hobby vehicle axle of the invention is designed to be used in mounting a wheel for rotation on the body of a wood vehicle, for example a vehicle constructed to compete in the Pinewood Derby® of the Boy Scouts of America®, and increase the speed of the vehicle. The length dimensions and the diameter dimensions of the axle are generally the same as those of an axle typically used in constructing a vehicle to compete in the Pinewood Derby®. However, the construction of the axle of the invention is modified from that of the prior art Pinewood Derby® axle to reduce the friction between a wheel mounted for rotation on the axle and thereby increase the speed of a hobby vehicle employing the axle of the invention.

The axle has a generally cylindrical length with opposite proximal and distal ends, and a center axis. The axle is constructed of the same metal materials employed in the prior art axles, and could also have a polished exterior surface to reduce friction.

The axle is provided with a pointed tip at the axle proximal end. The tip is employed in driving the axle into the wood vehicle body, as is conventional. Other configurations of the tip, for example a screw thread, could also be employed to drive the tip into the wood vehicle body.

The opposite distal end of the axle is provided with a head, as is also conventional. In the preferred embodiment an inboard surface of the head tapers as it extends both axially and radially toward the axle distal end. This tapered surface is provided to reduce surface contact between the head of the axle and the wheel of the vehicle, and thereby reduce friction between the axle and wheel.

The mounting length of the axle that extends between the tip at the proximal end and the head at the distal end is comprised of a shank portion of the axle and a wheel support portion of the axle. The shank portion of the axle is provided to be driven into the wood of the hobby vehicle body in mounting the axle to the vehicle body. This shank portion has a cylindrical exterior surface with a constant exterior diameter.

The wheel support portion of the vehicle axle has a novel construction designed to reduce friction between the axle and a wheel mounted for rotation on the axle. In the preferred embodiment of the invention, the wheel support portion of the axle is formed with three land sections that each have a cylindrical exterior surface. Each of the cylindrical land sections have a same exterior diameter dimension. In the preferred embodiment of the invention the lands are finished and the exterior diameter dimension of the three cylindrical land sections is slightly smaller than that of the shank portion of the axle.

A total of four grooves are formed in the exterior surface of the axle. The three land sections of the wheel support portion of the axle are separated axially from each other by two of the four grooves. The two grooves have exterior diameter dimensions that are smaller than the exterior diameter dimensions of the three land sections. A third of the four cylindrical grooves separates the three cylindrical land sections of the axle from the shank portion of the axle, and the fourth groove separates the three cylindrical land sections of the axle from the head portion of the axle.

With the wheel mounted on the wheel support portion of the axle, the wheel rotates on the cylindrical exterior surfaces of the three land sections of the axle. The grooves formed in the exterior surface of the axle reduce the area of surface contact between the axle and the center hole of the wheel, and thereby reduce the friction between the axle and the wheel. In addition, the cylindrical grooves that axially separate the three cylindrical land sections of the axle and separate the land sections from the shank portion and head portion of the axle provide areas around the axle for lubricant retention.

### BRIEF DESCRIPTION OF THE DRAWINGS

Further features of the hobby vehicle axle of the invention are set forth in the following detailed description and in the drawing figures.

FIG. 1 is a side view of the axle of the invention.

FIG. 2 is a representation of the axle of FIG. 1 mounting a wheel for rotation on a wood hobby vehicle.

### DETAILED DESCRIPTION OF THE PREFERRED EMBODIMENT

As stated earlier, the hobby vehicle axle of the invention 12 is designed to be used in mounting a wheel for rotation on the body of a wood vehicle, for example a vehicle constructed to compete in the Pinewood Derby® of the Boy Scouts of America®, and to increase the speed of the vehicle. Because the axle 12 is designed to replace conventional axles used in constructing vehicles to compete in the Derby, the length dimension of the axle 12 is essentially the same as that of the conventional axle. In addition, the materials employed in constructing the axle 12 of the invention can also be those materials employed in constructing conventional axles.

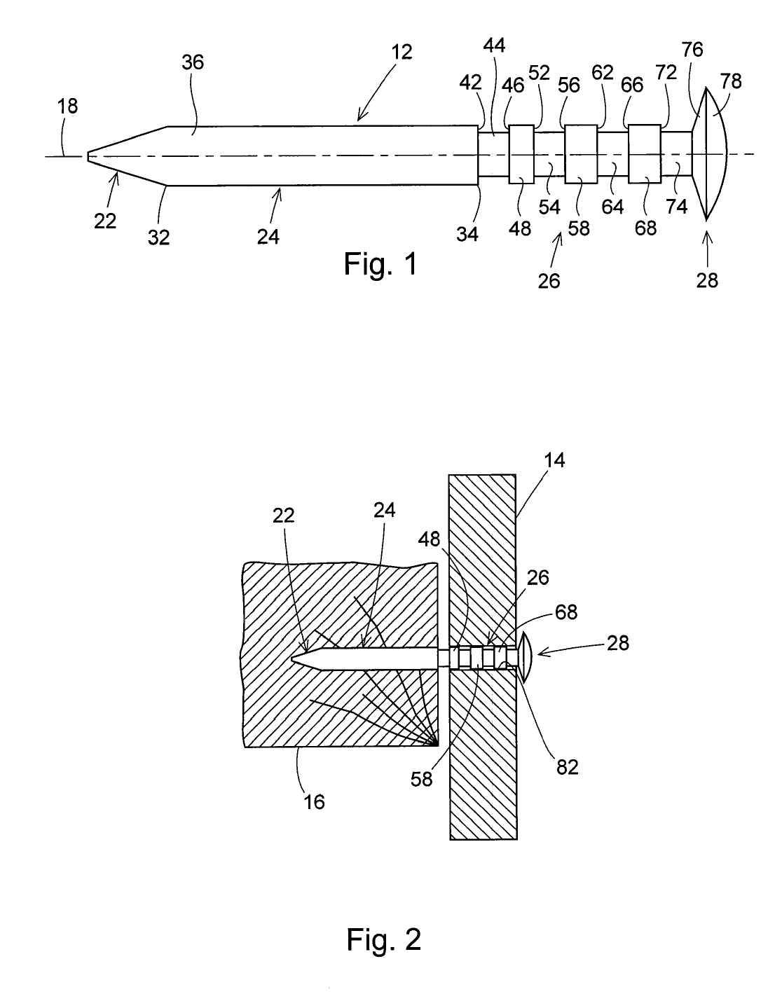

A side view of the axle of the invention 12 is shown in FIG. 1. FIG. 2 is a representation of the axle 12 shown mounting a wheel 14 to the wood body 16 of a hobby vehicle. With the axle of the invention 12 being an improvement over the conventional axles used in constructing the wood hobby vehicles, the axle 12 can be used in any conventional method of assembling the wheel 14 to the wood body of the vehicle 16.

Referring to FIG. 1, the axle 12 has a length with a center axis 18. The axle length is comprised of a tip portion 22, a shank portion 24, a wheel support portion 26, and a head portion 28. Each of these portions of the axle 12 are constructed integrally from a single piece of metal or other material typically employed in nails or screws.

The tip portion 22 shown in FIG. 1 has an exterior surface with a conical configuration, as is typical in many axles. The smooth conical surface of the tip portion 22 facilitates driving the tip portion into the wood body of a hobby vehicle. In other configurations of the tip portion 22, the exterior surface could be provided with a screw thread to facilitate driving the tip portion into the wood hobby vehicle body.

The axle shank portion 24 has a length with opposite proximal 32 and distal 34 ends. The length of the shank portion 24 is coaxial with the tip portion 22. The shank portion 24 has a cylindrical exterior surface 36. The exterior surface 36 is unfinished and has a constant diameter dimension for the entire axial length of the shank portion 24 from the proximal end 32 to the distal end 34. In the illustrative embodiment shown in FIG. 1, the exterior diameter dimension of the shank portion exterior surface 36 is 2.23 mm. The combined axial lengths of the shank portion 24 and the tip portion 22 are conventional and are determined to securely hold the axle 12 to the wood body of a hobby vehicle 16 when the tip portion 22 and shank portion 24 are driven into the hobby vehicle body.

The shank portion distal end 34 is formed with an annular end surface 42. The annular end surface 42 is positioned in a plane that is perpendicular to the axle center axis 18 and perpendicular to the shank portion exterior surface 36. In the illustrative embodiment shown in FIG. 1, the annular end surface 42 has a radial dimension that extends radially inwardly from the shank portion exterior surface 36 a dimension of 0.53 mm.

The axle has a first groove defined by a first cylindrical groove surface 44 that extends axially from the shank portion distal end 34 and axially from the interior of the annular end surface 42. In the illustrative embodiment of FIG. 1, the first groove surface 44 has an axial length of 1 mm. With the first groove surface 44 being positioned inside the annular end surface 42, the first groove surface has a constant diameter dimension of 1.17 mm for the entire axial length of the surface.

A second annular end surface 46 extends radially outwardly from the first groove surface 44. The second annular end surface 46 has a slightly smaller radial dimension of 0.050 mm compared to the radial dimension of the first annular end surface 42. Like the first annular end surface 42, the second annular end surface 46 is positioned in a plane that is perpendicular to the axle center axis 18.

A first cylindrical land 48 having a cylindrical exterior surface extends axially from the second annular end surface 46. The cylindrical exterior surface of the first land 48 is finished, and therefore the exterior diameter dimension of the first land 48 is slightly smaller than the exterior diameter dimension of the shank portion 24 of the axle. In the illustrative embodiment shown in FIG. 1, the exterior diameter dimension of the first land 48 is 2.18 mm. Also, in the illustrative embodiment shown in FIG. 1, the axial length of the first land 48 is 1.25 mm.

A third annular end surface 52 is provided on the axially opposite side of the first land 48 from the second annular end surface 46. The third annular end surface 52 has the same radial dimensions as the second annular end surface 46, and is also positioned in a plane that is perpendicular to the axle center axis 18.

A second groove defined by a second cylindrical groove surface 54 extends axially from the third annular end surface 52. The second cylindrical groove surface 54 has the same axial dimension and the same diameter dimension as the first groove surface 44.

A fourth annular end surface 56 extends radially outwardly from the second groove surface 54 on the axially opposite side of the second groove surface 54 from the third annular end surface 52. The fourth annular end surface 56 has the same radial dimensions as the third annular end surface 52 and is positioned in a plane that is perpendicular to the axle center axis 18.

A second land having a second cylindrical land surface 58 extends axially from the fourth annular end surface 56. The second land 58 has the same exterior diameter dimension as the first land surface 48. However, in the illustrative embodiment of FIG. 1, the cylindrical exterior surface of the second land 58 has an axial length dimension of 1.5 mm.

A fifth annular end surface 62 extends radially inwardly from an opposite side of the second land surface 58 from the fourth annular end surface 56. The fifth annular end surface 62 has the same radial dimensions as the fourth annular end surface 56 and is positioned in a plane that is perpendicular to the axle axis 18.

A third groove in the axle 12 is defined by a third cylindrical groove surface 64 that extends axially from the fifth annular end surface 62. The third groove surface 64 has the same exterior diameter dimension as the second groove surface 54 and also has the same axial dimension as the second groove surface 54.

A sixth annular end surface 66 extends radially outwardly from the third groove surface 64 on an opposite side of the third groove surface 64 from the fifth annular end surface 62. The sixth annular end surface 66 has the same radial dimension as the fifth annular end surface 62 and it is positioned in a plane that is perpendicular to the axle center axis 18.

A third land is defined by a third cylindrical land surface 68 that extends axially from the sixth annular end surface 66. The third land surface 68 has the same exterior diameter dimension as the second land surface 58 and also has the same axial length dimension as the second land surface 58.

A seventh annular end surface 72 extends radially inwardly from the third land surface 68 on an opposite side of the third land surface 68 from the sixth annular end surface 66. The seventh annular end surface 72 has the same radial dimensions as the sixth annular end surface 66 and is positioned in a plane that is perpendicular to the axle center axis 18.

A fourth groove in the axle 12 is defined by a fourth cylindrical groove surface 74 that extends axially from the seventh annular end surface 72. The fourth groove surface 74 has the same exterior diameter dimension as the third groove surface 64 and also has the same axial dimension as the third groove surface 64.

The axle head portion 28 extends both radially and axially from the fourth groove surface 74 on an opposite side of the fourth groove surface from the seventh annular end surface 72. The axle head portion has an inboard surface 76 that faces toward the axle wheel support portion 26. As seen in the illustrative embodiment of FIG. 1, the head portion inboard surface 76 simultaneously extends both axially and radially away from the fourth groove surface 74. In the illustrative embodiment of FIG. 1, the inboard surface 76 forms an angle of substantially 30 degrees relative to a plane positioned perpendicular to the axle center axis 18. The inboard surface 76 extends radially outwardly to a maximum exterior diameter dimension of the head portion 28 that is conventionally determined to be larger than the hole through the wheel 14 of a Derby vehicle.

The axle head portion 28 also has an outboard surface 78 as shown in FIG. 1. In the embodiment of the axle 12 shown in FIG. 1, the head portion outboard surface 78 has a generally convex configuration. In alternate embodiments of the axle 12, the outboard surface 78 could have another configuration, and could also be substantially flat.

FIG. 2 gives an illustrative example of the axle 12 mounting a wheel 14 to the body of a hobby vehicle 16. As shown in FIG. 2, the axle 12 is mounted on the vehicle body 16 by driving the tip portion 22 and the shank portion 24 into the wood body. Thus, the first annular end surface 42 of the axle is positioned substantially parallel to a side surface of the vehicle body 16. The wheel 14 is mounted on the axle 12 so that the interior surface of the wheel center hole 82 is supported in sliding engagement against the exterior surfaces of the first land surface 48, the second land surface 58, and the third land surface 68. Due to the presence of the first groove surface 44, the second groove surface 54, the third groove surface 64, and the fourth groove surface 74, the total area of friction contact between the axle 12 and the wheel 14 and the friction force associated with that contact is reduced. In this way, the axle 12 of the invention mounts a wheel 14 for rotation while substantially reducing the friction between the wheel 14 and axle 12 from that present in prior art axles. In addition, the presence of the multiple grooves between the center hole of the wheel 14 and the groove surfaces 44, 54, 64, 74 of the axle 12 allows for the retention of a lubricant in the grooves that will further reduce the friction between the wheel 14 and the axle 12 of the invention.

In view of the foregoing, it will be seen that the several advantages of the invention are achieved and attained.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An axle for mounting a wheel for rotation on a hobby vehicle body, the axle comprising:
a tip that is shaped to facilitate driving the tip into a hobby vehicle body in mounting a wheel on the axle to the hobby vehicle body;
a cylindrical exterior surface having a center axis that defines mutually perpendicular axial and radial directions relative to the axle, the tip being at one end of the exterior surface, the exterior surface having a shank portion with a constant exterior diameter dimension that facilitates driving the shank portion into the hobby vehicle body, and the exterior surface having a wheel support portion having at least three axially spaced cylindrical grooves around the exterior surface and at least two cylindrical lands around the exterior surface that are axially separated by the at least three grooves, the at least two lands having a same exterior diameter dimension, the at least three grooves reducing friction from rotation of the wheel on the at least two lands of the axle; and,
a head at an opposite end of the exterior surface from the tip, the head having a larger exterior diameter dimension than the shank portion of the exterior surface.

2. The axle of claim 1, further comprising:
the at least two lands having exterior diameter dimensions that are smaller than the exterior diameter dimension of the shank portion.

3. The axle of claim 1, further comprising:
the at least three grooves having a same exterior diameter dimension.

4. The axle of claim 1, further comprising:
the at least three grooves having a same axial length.

5. The axle of claim 1, further comprising:
one groove of the at least three grooves being positioned axially between the head and one land of the at least two lands.

6. The axle of claim 1, further comprising:
the at least three grooves around the wheel support portion being three of four cylindrical grooves around the exterior surface of the wheel support portion.

7. The axle of claim 6, further comprising:
the at least two lands around the exterior surface being two of three cylindrical lands around the exterior surface wheel support portion and the four grooves axially separating the three lands.

8. The axle of claim 7, further comprising:
each of the three lands having an exterior diameter dimension that is larger than the exterior diameter dimensions of the four cylindrical grooves.

9. The axle of claim 7, further comprising:
one groove of the four grooves axially separating the three cylindrical lands from the axle head.

10. The axle of claim 7, further comprising:
one groove of the four grooves axially separating the three lands from the axle shank portion.

11. The axle of claim 7, further comprising:
the three lands having a smaller exterior diameter dimension than the axle shank portion.

12. The axle of claim 7, further comprising:
the four grooves having a same exterior diameter dimension.

13. The axle of claim 1, further comprising:
the hobby vehicle body being constructed of wood.

14. An axle for mounting a wheel for rotation on a wood hobby vehicle body, the axle comprising:
a shank portion having a length with opposite proximal and distal ends, the shank portion having a cylindrical exterior surface with a center axis that defines mutually perpendicular axial and radial directions relative to the axle, the shank portion having a constant exterior diameter dimension for the entire length of the shank portion;
a conical tip extending axially from the shank portion proximal end, the tip being coaxial with the shank portion and being shaped to facilitate driving the tip and the shank portion into the wood hobby vehicle body;
a wheel support portion extending axially from the shank portion distal end, the wheel support portion being coaxial with the shank portion, the wheel support portion having four cylindrical grooves and three cylindrical lands that are axially separated by the four cylindrical grooves; and,
a head portion extending axially from the wheel support portion on an opposite side of the wheel support portion from the shank portion, the head portion having an exterior diameter dimension that is larger than the shank portion exterior diameter dimension.

15. The axle of claim 14, further comprising:
the three cylindrical lands having exterior diameter dimensions that are larger than the exterior diameter dimensions of the four cylindrical grooves.

16. The axle of claim 15, further comprising:
the three cylindrical lands having a same exterior diameter dimension.

17. The axle of claim 16, further comprising:
one cylindrical groove of the four cylindrical grooves axially separating the three cylindrical lands from the axle head.

18. The axle of claim 17, further comprising:
one cylindrical groove of the four cylindrical grooves axially separating the three cylindrical lands from the axle shank portion.

19. The axle of claim 14, further comprising:
the three cylindrical lands and the axle shank portion having a same exterior diameter dimension.

20. An axle for mounting a wheel for rotation on a hobby vehicle body, the axle comprising:
a shank portion having a length with opposite proximal and distal ends, the shank portion having a cylindrical exterior surface with a constant exterior diameter dimension that extends the entire length of the shank portion, and a center axis that defines mutually perpendicular axial and radial directions relative to the axle;
a conical tip that is formed integrally with the shank portion at the shank portion proximal end, the conical tip being dimensioned to facilitate driving the conical tip and the shank portion into a hobby vehicle body, the conical tip and the shank portion being coaxial;
a wheel support portion that is formed integrally with the shank portion at the shank portion distal end, the wheel support portion and the shank portion being coaxial, the wheel support portion having a plurality of sections with cylindrical exterior surfaces with different exterior diameter dimensions including a first section that extends axially from the shank portion distal end and has an exterior diameter dimension that is smaller than the shank portion exterior diameter dimension, a second section that extends axially from the first section and has an exterior diameter dimension that is larger than the exterior diameter dimension of the first section, a third section that extends axially from the second section and has an exterior diameter dimension that is smaller than the exterior diameter dimension of the second section, a fourth section that extends axially from the third section and has an exterior diameter dimension that is larger than the exterior diameter of the third section, a fifth section that extends axially from the fourth section and has an exterior diameter dimension that is smaller than the exterior diameter dimension of the fourth section, a sixth section that extends axially from the fifth section and has an exterior diameter dimension that is larger than the exterior diameter dimension of the fifth section, and a seventh section that extends axially from the sixth section and has an exterior diameter dimension that is smaller than the exterior diameter dimension of the sixth section; and,
a head portion that is formed integrally with the wheel support portion, the head portion and the wheel support portion being coaxial, the head portion having an annular inboard surface that faces toward the wheel support portion, the inboard surface extending radially outwardly from the seventh section of the wheel support portion and simultaneously extending axially from the seventh section of the wheel support portion, and the head portion having a disk-shaped outboard surface on an opposite side of the head portion from the inboard surface.

21. The axle of claim 20, further comprising:
the second section, fourth section, and sixth section of the wheel support portion having a same exterior diameter dimension.

22. The axle of claim 20, further comprising:
the shank portion and the wheel support portion second, fourth and sixth sections having a same exterior diameter dimension.

23. The axle of claim 20, further comprising:
the first section, third section, fifth section, and seventh section of the wheel support portion having a same exterior diameter dimension.

24. The axle of claim 20, further comprising:
the first section, third section, fifth section, and seventh section of the wheel support portion having a same axial length.
